(19) United States
(12) Patent Application Publication
(10) Pub. No.: US 2025/0324193 A1
(43) Pub. Date: Oct. 16, 2025

(54) SOUND COLLECTING DEVICE

(71) Applicant: HONDA MOTOR CO., LTD., Tokyo (JP)

(72) Inventors: Susumu AKUTSU, Tokyo (JP); Shogo IGUCHI, Tokyo (JP)

(21) Appl. No.: 19/074,520

(22) Filed: Mar. 10, 2025

(30) Foreign Application Priority Data
Apr. 15, 2024 (CN) 202410445977.8

(51) Int. Cl. H04R 1/28; H04R 1/08; H04R 1/34

(52) U.S. Cl. CPC H04R 1/2807; H04R 1/08; H04R 1/342

(57) ABSTRACT

To provide a sound collecting device capable of simultaneously generating resonance in a plurality of frequency bands. A sound collecting device 1 includes: a plurality of resonant tubes 10 of different lengths, each formed in a tubular shape and having a sound collecting opening 20 formed at an opening-side end portion 22; and a microphone 50 disposed at a microphone-side end portion 24 of the resonant tube 10. The resonant tube 10 has a reflecting surface 28 extending toward the inside of the resonant tube 10 at predetermined distances from the sound collecting opening 20 and the microphone 50.

### CROSS REFERENCE TO RELATED APPLICATIONS

This application claims the benefit of priority to Chinese Patent Application No. CN202410445977.8 filed on Apr. 15, 2024. The entire contents of this application are hereby incorporated herein by reference.

### BACKGROUND OF THE INVENTION

### Field of the Invention

The present invention relates to a sonic microphone that improves a signal-to-noise (S/N) ratio in an abnormal frequency range.

### Related Art

A sound collector that can amplify and capture sound is known. Japanese Unexamined Patent Application, Publication No. 2011-223537 discloses a sound collector for collecting sounds, in which a plurality of resonant tubes of different lengths, having open end portions, are bundled together at the other end portions and mounted in a sealed state close to a condenser microphone.

Patent Document 1: Japanese Unexamined Patent Application,

### SUMMARY OF THE INVENTION

However, the sound collector of Japanese Unexamined Patent Application, Publication No. 2011-223537 has a structure in which the plurality of resonant tubes are bundled together in front of the microphone and connected thereto. Therefore, in the sound collector of Japanese Unexamined Patent Application, Publication No. 2011-223537, each resonant tube does not resonate independently. In the sound collector of Japanese Unexamined Patent Application, Publication No. 2011-223537, resonance occurs at the total length of the connected tubes. As a result, in the sound collector of Japanese Unexamined Patent Application, Publication No. 2011-223537, even though the plurality of resonant tubes of different lengths are provided, resonance cannot be generated simultaneously in a plurality of frequency bands.

Accordingly, it is an object of the present invention to provide a sound collecting device capable of simultaneously generating resonance in a plurality of frequency bands.

A sound collecting device of the present invention includes: a plurality of resonant tubes of different lengths, each formed in a tubular shape and having a sound collecting opening formed at one end portion; and a microphone disposed at an other end portion of each of the resonant tubes. Each of the resonant tubes has a reflecting surface extending toward the inside of the resonant tube at a predetermined distance from the sound collecting opening and the microphone.

### Action Effect

According to the above sound collecting device, each of the resonant tubes has the reflecting surface extending toward the inside of the resonant tube at a predetermined distance from the sound collecting opening and the microphone, so that sound waves entering through the sound collecting opening are reflected by the reflecting surface and resonance can thus be generated in the section between the sound collecting opening and the reflecting surface. Therefore, even when the plurality of resonant tubes are bundled together and connected to the microphone, each resonant tube can generate resonance independently, and by varying the lengths of the respective resonant tubes, sound can be collected with a plurality of frequency bands amplified simultaneously.

According to the above sound collecting device, the microphone characteristics are adjusted, and resonant sound collecting tubes that make sound in an abnormal frequency range easier to hear are used to improve the S/N ratio in the abnormal frequency range and reduce noise in a noise frequency range, thereby achieving the detection of abnormal sounds beyond human sensitivity. Furthermore, it is possible to provide a sound collecting device capable of simultaneously generating resonance in a plurality of frequency bands.

In the above sound collecting device, the resonant tube may include a sound collecting resonator formed to include the sound collecting opening, the reflecting surface, and a section extending from the sound collecting opening to the reflecting surface, and a narrow tube portion that is formed with a smaller cross-sectional area than the sound collecting resonator and connects the sound collecting resonator to the microphone.

According to the above sound collecting device, the sound collecting resonator is connected to the microphone by the narrow tube portion thinner than the sound collecting resonator, so that the microphone can be prevented from becoming larger even when the plurality of resonant tubes are connected to the microphone.

In the above sound collecting device, the narrow tube portion may be formed with a smaller cross-sectional area than the outer shape of the microphone.

In the above sound collecting device, since the narrow tube portion is formed to be thinner than the outer shape of the microphone, the narrow tube portion and the inner space of the microphone can generate Helmholtz resonance, thereby enabling sound collection with the desired frequency band further amplified.

In the above sound collecting device, the sound collecting opening may be formed on a sound collecting surface that is formed of a flat surface facing the microphone, each of the resonant tubes may be disposed around the microphone, and among the plurality of resonant tubes of different lengths, the resonant tube with a shorter overall length of the sound collecting resonator may be disposed on a center side, and the resonant tube with a longer overall length of the sound collecting resonator may be disposed outside the resonant tube with the shorter overall length of the sound collecting resonator.

According to the above sound collecting device, the distance from the microphone to the sound collecting opening can be set short, so that the device does not become larger even when sound collecting tubes of different lengths are provided.

In the above sound collecting device, the narrow tube portion may include a plurality of narrow tube portions, and a plurality of the narrow tube portions may be combined and connected to the microphone.

According to the above sound collecting device, a plurality of narrow tube portions are combined into one and connected to the microphone, so that the microphone can be made smaller even when the plurality of resonant tubes are provided.

According to the present invention, it is possible to provide a sound collecting device capable of simultaneously generating resonance in a plurality of frequency bands.

### BRIEF DESCRIPTION OF THE DRAWINGS

FIG. 1 is a perspective view of a sound collecting device according to an embodiment of the present invention;

FIG. 2 is a view illustrating the sound collecting surface of the sound collecting device of FIG. 1;

FIG. 3 is a view illustrating the back surface of the sound collecting device of FIG. 1;

FIG. 4 is a cross-sectional view taken along line A-A of FIG. 2;

FIG. 5 is a simplified view of a one-sided closed resonance model;

FIG. 6 is a partially enlarged view of FIG. 4;

FIG. 7 is a partially enlarged view of FIG. 4;

FIG. 8 is a cross-sectional view taken along line A-A of FIG. 2;

FIG. 9 is an enlarged perspective view of the back surface of the sound collecting device;

FIG. 10 is a partially enlarged view of FIG. 4;

FIG. 11 is a perspective cross-sectional view of the sound collecting device; and

FIG. 12 is a cross-sectional view of the sound collecting device taken along line J-J of FIG. 11.

### DETAILED DESCRIPTION OF THE INVENTION

### Outline of Sound Collecting Device

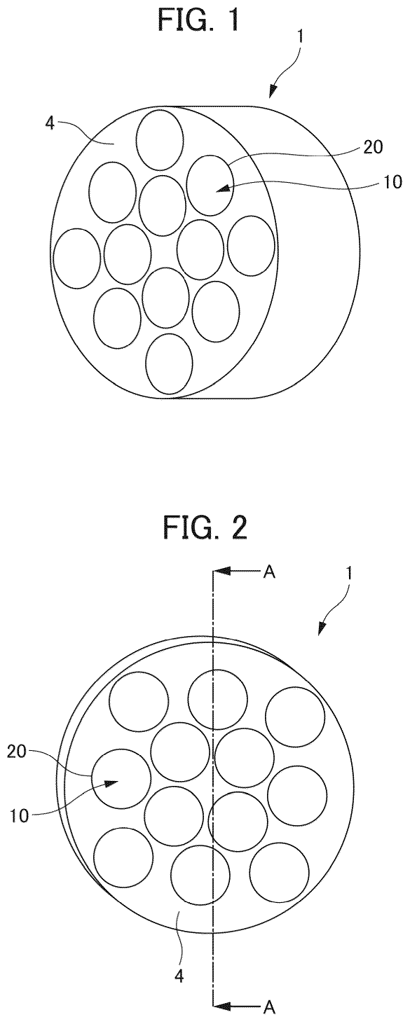

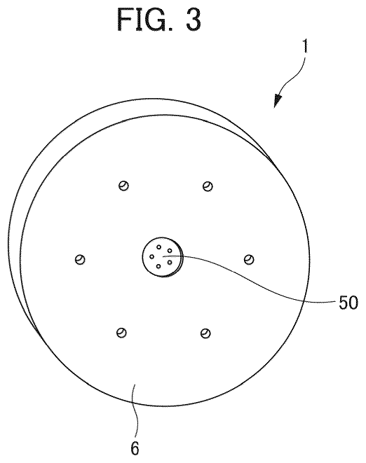

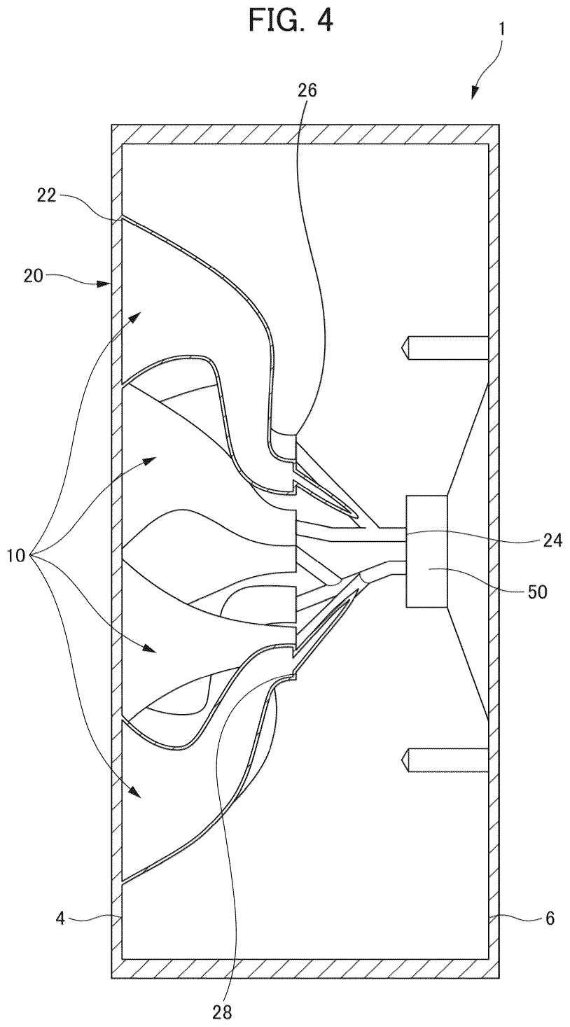

An embodiment of the present invention will be described below with reference to the drawings. FIG. 1 is a perspective view of a sound collecting device 1 according to the embodiment of the present invention. As illustrated in FIG. 1, the sound collecting device 1 has a substantially columnar shape. In the sound collecting device 1, one of two opposing surfaces included in the columnar shape is referred to as a sound collecting surface 4. The other of the two surfaces is referred to as a back surface 6. FIG. 2 is a view illustrating the sound collecting surface 4 of the sound collecting device 1. FIG. 3 is a view illustrating the back surface 6 of the sound collecting device 1. FIG. 4 is a cross-sectional view taken along line A-A of FIG. 2.

### One-Sided Closed Resonance Model

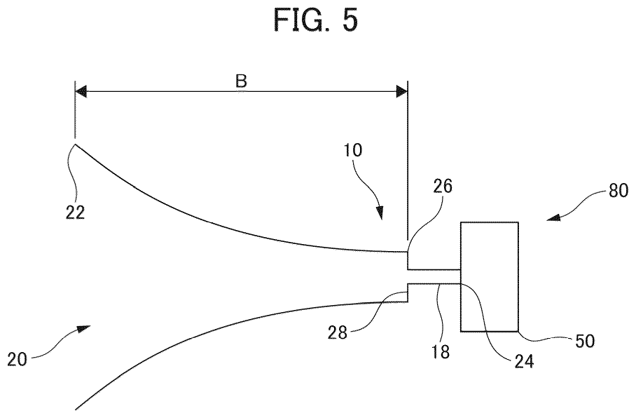

As illustrated in FIG. 4, the sound collecting device 1 includes a plurality of resonant tubes 10 and a microphone 50. Each of the resonant tubes 10 is a tube within which the collected sound resonates. The sound collecting device 1 is configured as a one-sided closed resonance model 80. FIG. 5 is a simplified view of a part of the sound collecting device 1 as the one-sided closed resonance model 80. FIG. 5 illustrates one resonant tube 10 and the microphone 50 as components of the one-sided closed resonance model 80. One end portion of the resonant tube 10 is referred to as an opening-side end portion 22. A sound collecting opening 20 is formed at the opening-side end portion 22. The other end portion of the resonant tube 10 is referred to as a microphone-side end portion 24. The microphone 50 is disposed at the microphone-side end portion 24.

In the sound collecting device 1 of the present embodiment, a portion is formed in the resonant tube 10 where the inner diameter of the resonant tube 10 is reduced. The portion where the inner diameter is reduced is illustrated as a resonance end 26 in FIG. 5. The formation of the portion in the resonant tube 10 where the inner diameter of the resonant tube 10 is reduced causes resonance in the resonant tube 10 even when the resonant tube 10 is not completely closed on one side. Double-sided arrow B in FIG. 5 indicates a section between the opening-side end portion 22 and the resonance end 26. In the one-sided closed resonance model 80 illustrated in FIG. 5, resonance occurs in the section indicated by double-sided arrow B. Methods of forming the portion where the inner diameter is reduced in the resonant tube 10 include forming a reflecting surface 28 in the resonant tube 10 and forming a narrow tube portion 18 in the resonant tube 10. The reflecting surface 28 and the narrow tube portion 18 will be described later.

### Plurality of Resonance Frequencies

As illustrated in FIG. 1, the sound collecting device 1 includes 12 resonant tubes 10. In the sound collecting device 1, 12 different resonance frequencies can be set. It is possible to set 12 resonance frequencies at 400 Hz pitch, for example, from 2.1 kHz to 6.5 kHz.

By adopting a one-sided closed resonant tube structure for the sound collecting device 1 of the present embodiment, one resonant tube 10 can generate resonance independently. Arranging the plurality of resonant tubes 10 as described above in parallel enables the sound collecting device 1 of the present embodiment to perform signal amplification aiming at a specific frequency by overlapping resonances. Hereinafter, each portion will be described in order.

### Reflecting Surface

As illustrated in FIG. 1 and other figures, the sound collecting device 1 is formed in a tubular shape. As illustrated in FIG. 4, the sound collecting opening 20 is formed at the opening-side end portion 22, which is one end portion of the resonant tube 10. The sound collecting device 1 includes the plurality of resonant tubes 10 of different lengths. The length refers to the actual length of the resonant tube 10 from the opening-side end portion 22 to the microphone-side end portion 24, not the shortest distance from the opening-side end portion 22 to the microphone-side end portion 24. When the resonant tube 10 has a tortuous shape, the actual length of the resonant tube 10 corresponds to the length of the tortuous pipe extended straight. In FIG. 1 and other figures, as the sound collecting device 1, a sound collecting device 1 with a cylindrical shape is exemplified. However, the shape of the sound collecting device 1 is not limited to a cylindrical shape. That is, the tubular shape described above includes not only a cylindrical shape but also a tubular shape with corners, such as a square or a triangle. The sound collecting device 1 may have a tubular shape with corners or flat surfaces on the outside.

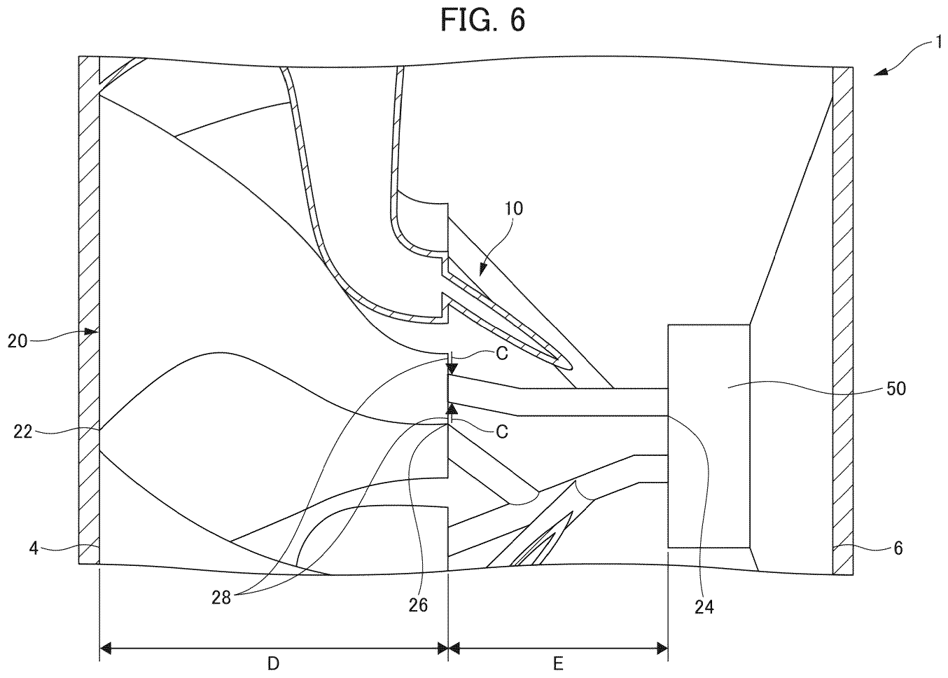

FIG. 6 is a partially enlarged view of FIG. 4. As illustrated in FIG. 6, the microphone 50 is disposed at the microphone-side end portion 24, which is the other end portion of the resonant tube 10. The sound collecting device 1 of the present embodiment has a reflecting surface 28 at a predetermined distance from the sound collecting opening 20 and at a predetermined distance from the microphone 50.

The reflecting surface 28 extends from the inner wall of the resonant tube 10 toward the inside of the resonant tube 10. Arrow C in FIG. 6 indicates a direction C toward the inside of the resonant tube 10. The direction C can be a direction orthogonal to the direction from the opening-side end portion 22 toward the microphone-side end portion 24. The reflecting surface 28 extends from the inner wall of the tubular resonant tube 10 toward the center of the tube. Sound entering the resonant tube 10 through the sound collecting opening 20 resonates between the sound collecting opening 20 and the reflecting surface 28. The position where the reflecting surface 28 is disposed is the resonance end 26.

Double-sided arrow D in FIG. 6 indicates a distance D from the sound collecting opening 20 to the reflecting surface 28. Double-sided arrow E in FIG. 6 indicates a distance E from the microphone 50 to the reflecting surface 28. The distance D and the distance E can be determined based on the frequency at which signal amplification is to be performed and other related factors.

### Microphone

The microphone 50 can be, for example, a condenser microphone. The resonance frequency of the microphone 50 can be, for example, 6 kHz. As illustrated in FIG. 3, the microphone 50 is disposed at the center position of the sound collecting device 1 in a plane view from the back surface 6.

In the sound collecting device 1 of the present embodiment, the resonant tube 10 has a reflecting surface 28 extending toward the inside of the resonant tube 10 at predetermined distances from the sound collecting opening 20 and the microphone 50. Thus, sound waves entering the resonant tube 10 through the sound collecting opening 20 are reflected by the reflecting surface. This makes it possible to generate resonance in the section from the sound collecting opening 20 to the reflecting surface 28. Therefore, even when the plurality of resonant tubes 10 are bundled together and connected to the microphone 50, each resonant tube 10 can generate resonance independently. As a result, by varying the lengths of the respective resonant tubes 10, sound can be collected with a plurality of frequency bands amplified simultaneously.

In the sound collecting device 1 of the present embodiment, the microphone characteristics are adjusted and the resonant sound collecting tubes that make sound in an abnormal frequency range easier to hear are used to improve the S/N ratio in an abnormal frequency range and to reduce noise in a noise frequency range, whereby the detection of abnormal sounds beyond human sensitivity can be achieved. For example, the sound collecting device 1 of the present embodiment can achieve 105 dB, which exceeds the estimated sensitivity of 95 dB for humans.

### Sound Collecting Resonator and Narrow Tube Portion

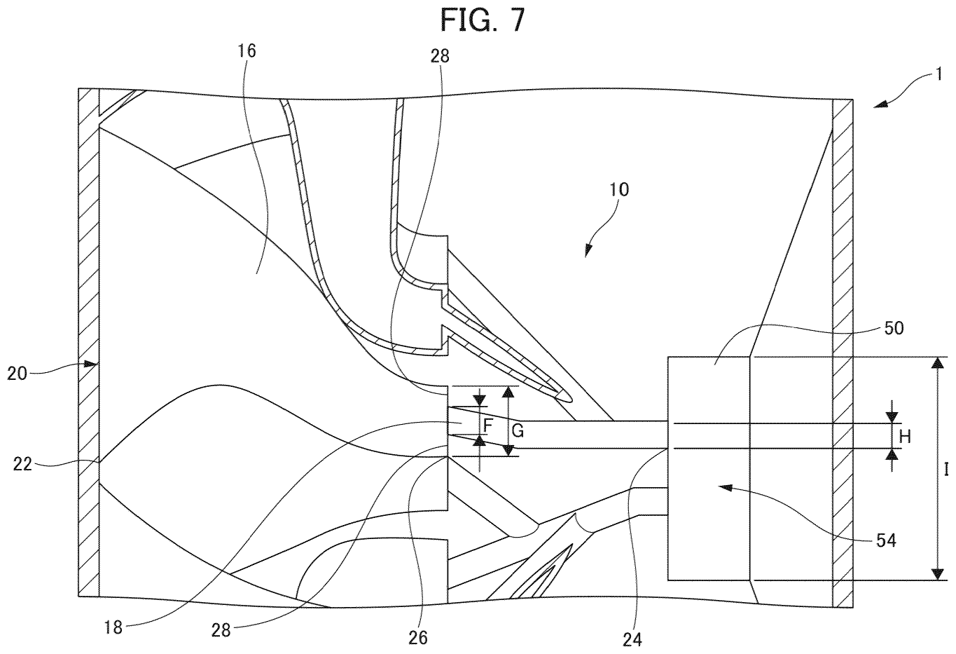

FIG. 7 is a partially enlarged view of FIG. 4, similar to FIG. 6. As illustrated in FIG. 7, the resonant tube 10 includes a sound collecting resonator 16 and a narrow tube portion 18. The sound collecting resonator 16 is a portion formed to include the sound collecting opening 20, the reflecting surface 28, and a section therebetween. In the sound collecting resonator 16, the collected sound is resonated by the one-sided closed resonance model. The narrow tube portion 18 is a portion formed from the reflecting surface 28 to the microphone 50. The narrow tube portion 18 is a portion that connects the sound collecting resonator 16 to the microphone 50. The narrow tube portion 18 is formed with a smaller cross-sectional area than the sound collecting resonator 16.

The outer diameter of the sound collecting resonator 16 at the resonance end 26 where the reflecting surface 28 is formed is indicated by double-sided arrow G in FIG. 7. The outer diameter of the narrow tube portion 18 at the portion in contact with the rear surface of the reflecting surface 28 is indicated by double-sided arrow F in FIG. 7. The outer diameter F of the narrow tube portion 18 is smaller than the outer diameter G of the sound collecting resonator 16. In the sound collecting device 1 of the present embodiment, the sound collecting resonator 16 is connected to the microphone 50 by the narrow tube portion 18 that is thinner than the sound collecting resonator 16. Therefore, even when the plurality of resonant tubes 10 are connected to the microphone 50, the microphone 50 can be prevented from becoming larger. Note that the outer diameter G of the sound collecting resonator 16 on the reflecting surface 28 can be 4.8 mm, for example. The outer diameter F of the narrow tube portion 18 at the portion in contact with the reflecting surface 28 can be 2 mm, for example.

### Cross-Sectional Area of Narrow Tube Portion

The narrow tube portion 18 is formed with a cross-sectional area smaller than the outer shape of the microphone 50. The outer diameter of the narrow tube portion 18 at the portion where the narrow tube portion 18 contacts the microphone 50 is indicated by double-sided arrow H in FIG. 7. The outer diameter of the microphone 50 is indicated by double-sided arrow I in FIG. 7. The outer diameter H of the narrow tube portion 18 at the portion in contact with the microphone 50 is smaller than the outer shape I of the microphone 50. When the microphone 50 is cylindrical, for example, the outer diameter I of the microphone 50 is the outer diameter of the microphone 50.

In the sound collecting device 1 of the present embodiment, the narrow tube portion 18 is formed thinner than the outer shape I of the microphone 50. Therefore, the narrow tube portion 18 and an inner space 54 of the microphone 50 can generate Helmholtz resonance. As a result, sound can be collected with the desired frequency band further amplified.

### Sound Collecting Surface

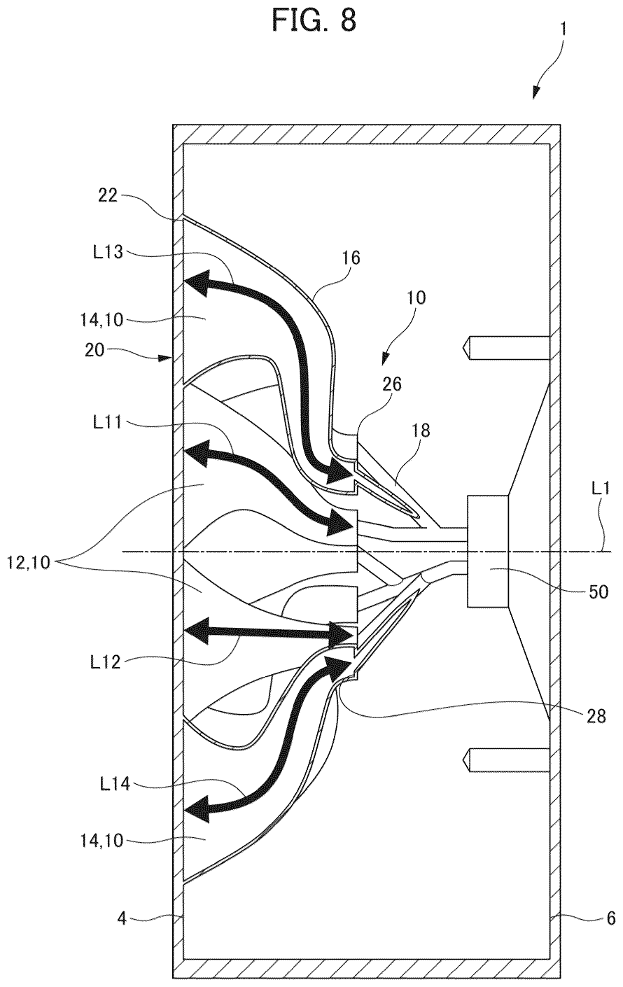

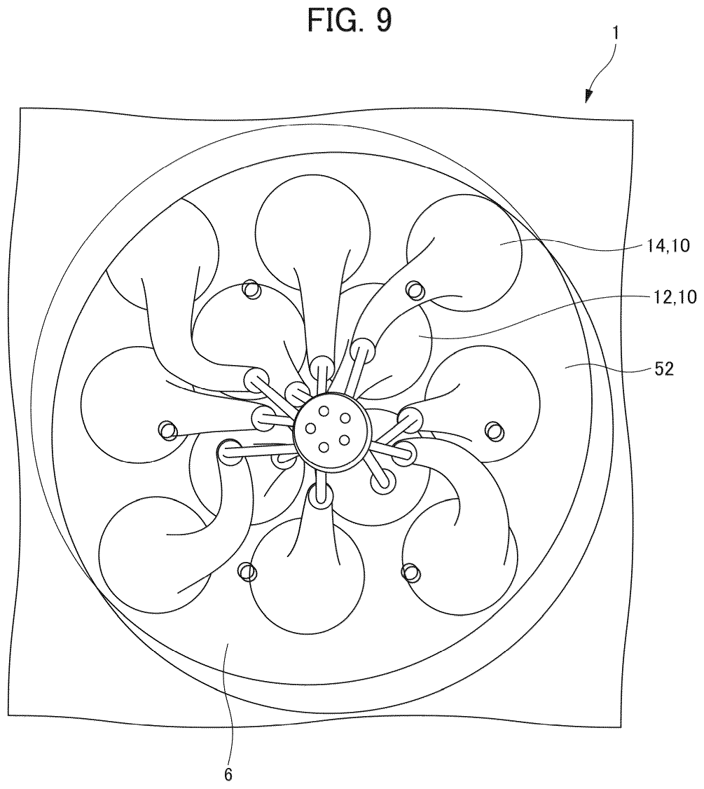

FIG. 8 is a cross-sectional view taken along line A-A of FIG. 2, similar to FIG. 4. The flat surface facing the microphone 50 in the sound collecting device 1 is referred to as the sound collecting surface 4. The sound collecting surface 4 is formed of the flat surface. The sound collecting opening 20 of each resonant tube 10 is formed on the sound collecting surface 4.

### Arrangement of Resonant Tubes

The resonant tubes 10 are arranged around the microphone 50. Line L1 in FIG. 8 indicates the center of the microphone 50. As illustrated in FIG. 8, in a cross-sectional view, each resonant tube 10 is disposed at a position substantially symmetrical to the center line L1 of the microphone 50. FIG. 9 is an enlarged perspective view of the back surface of the sound collecting device 1. FIG. 9 illustrates a state in which the microphone 50 has been removed from the sound collecting device 1. The microphone 50 is mounted on a microphone mount 52 illustrated in FIG. 9. The microphone mount 52 is located at the center of the back surface 6. As illustrated in FIG. 9, the resonant tubes 10 are arranged radially around the microphone mount 52.

### Shorter Resonant Tube and Longer Resonant Tube

The resonant tubes 10 include the plurality of resonant tubes 10 of different lengths. Each of the plurality of resonant tubes 10 of different lengths is classified as either a resonant tube 10 with a shorter overall length of the sound collecting resonator 16 or a resonant tube 10 with a longer overall length of the sound collecting resonator 16. The resonant tube 10 with a shorter overall length of the sound collecting resonator 16 is referred to as a shorter resonant tube 12. The resonant tube 10 with a longer overall length of the sound collecting resonator 16 is referred to as a longer resonant tube 14.

Each of double-sided arrows L11 to L14 illustrated in FIG. 8 indicates the overall length of the sound collecting resonator 16. The overall length of the sound collecting resonator 16 is the length from the opening-side end portion 22 to the reflecting surface 28. In other words, the overall length of the sound collecting resonator 16 is the length from the opening-side end portion 22 to the resonance end 26. L11 and L12 each indicate the length of the shorter resonant tube 12. L13 and L14 each indicate the length of the longer resonant tube 14. The lengths of L13 and L14 are longer than the lengths of L11 and L12.

The length refers to the actual length of the sound collecting resonator 16 from the opening-side end portion 22 to the reflecting surface 28, not the shortest distance from the opening-side end portion 22 to the reflecting surface 28. When the sound collecting resonator 16 is tortuous, the actual length of the sound collecting resonator 16 corresponds to the length of the tortuous pipe extended straight.

Note that the length of L13 differs from the length of L14. Similarly, the length of L11 differs from the length of L12. This is because each resonant tube 10 is designed to have a different resonance frequency.

As illustrated in FIGS. 8 and 9, the shorter resonant tube 12 is disposed more centrally than the longer resonant tube 14. The longer resonant tube 14 is disposed more outwardly than the shorter resonant tube 12. By arranging the resonant tubes 10 in this way, the distance from the microphone 50 to the sound collecting opening 20 can be set short in the sound collecting device 1 of the present embodiment. As a result, the sound collecting device 1 does not become larger even when the resonant tubes 10 of different lengths are provided.

### Combination of Narrow Tube Portions

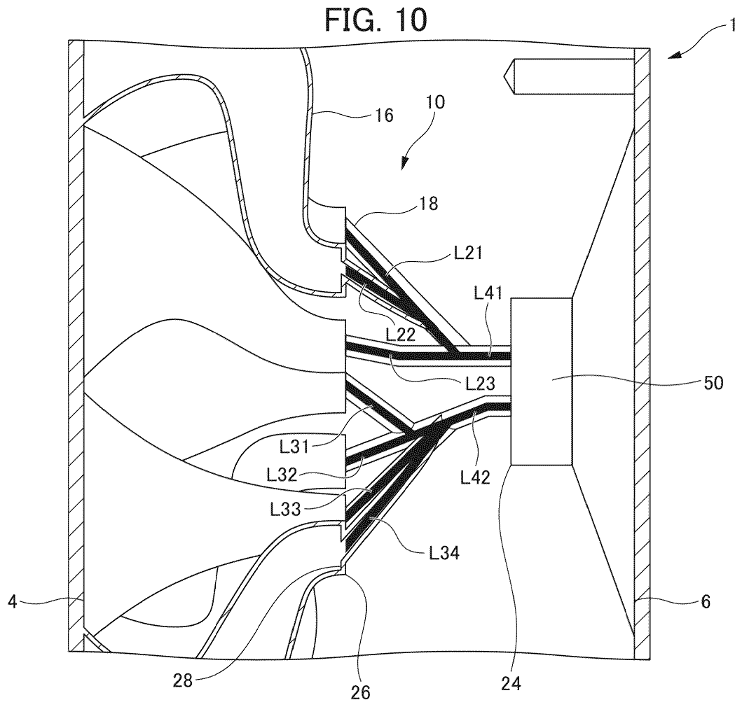

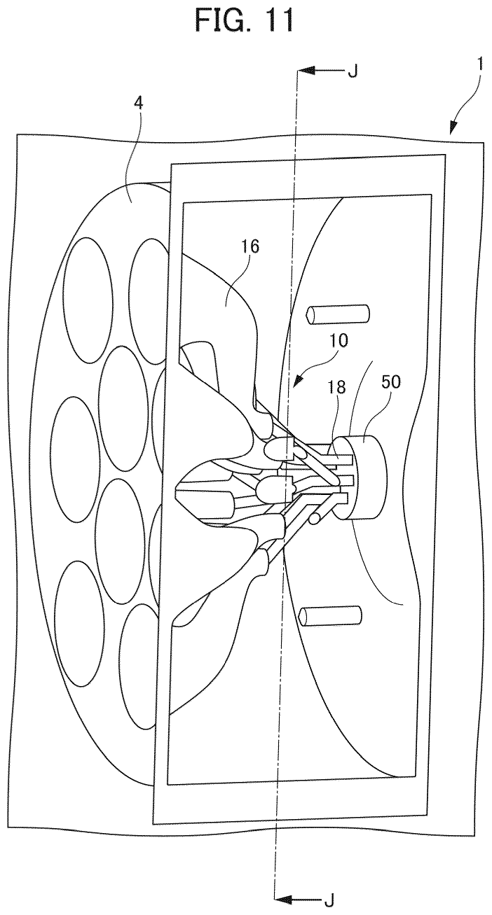

FIG. 10 is a partially enlarged view of FIG. 4, similar to FIG. 6. Lines L21 to L23, lines L31 to L34, and lines 41 and 42 illustrated in FIG. 10 indicate the arrangement of the narrow tube portions 18. Lines L21 to L23 and lines L31 to L34 illustrated in FIG. 10 are respectively connected to different sound collecting resonators 16. In the sound collecting device 1 of the present embodiment, a plurality of narrow tube portions 18 are combined and connected to the microphone 50. In the example illustrated in FIG. 10, the narrow tube portions 18 indicated by lines L21 to L23 are combined into one narrow tube portion 18 indicated by line L41 and connected to the microphone 50. Similarly, the narrow tube portions 18 indicated by lines L31 to L34 are combined into one narrow tube portion 18 indicated by line L42 and connected to the microphone 50.

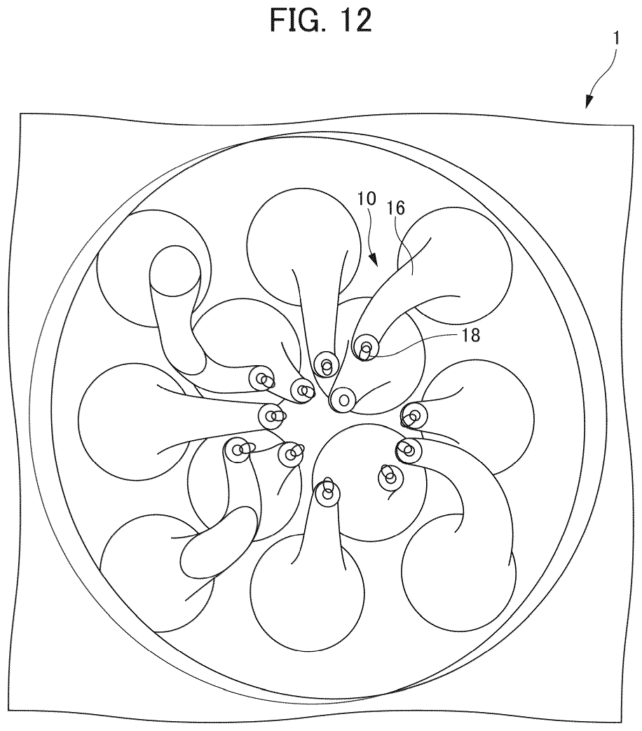

FIG. 11 is a perspective cross-sectional view of the sound collecting device 1 in a plane orthogonal to the sound collecting surface 4. FIG. 12 is a cross-sectional view of the sound collecting device 1 in line J-J illustrated in FIG. 11. As illustrated in FIG. 11, the narrow tube portion 18 extending from the sound collecting resonator 16 is combined with other narrow tube portions 18 and then connected to the microphone 50. By combining the narrow tube portions 18, the 12 narrow tube portions 18, as illustrated in FIG. 12, are reduced to fewer than 12 narrow tube portions 18, as illustrated in FIG. 11, and are connected to the microphone 50. Thus, in the sound collecting device 1 of the present embodiment, a plurality of narrow tube portions 18 are combined into one and connected to the microphone 50. Therefore, the microphone 50 can be made smaller even when a plurality of resonant tubes 10 are provided.

The embodiment of the present invention has been described above. The present invention is not limited to the embodiment described above, and various changes, modifications, and combinations are possible.

### EXPLANATION OF REFERENCE NUMERALS

1 sound collecting device
4 sound collecting surface
6 back surface
10 resonant tube
12 shorter resonant tube
14 longer resonant tube
16 sound collecting resonator
18 narrow tube portion
20 sound collecting opening
22 opening-side end portion (one end portion)
24 microphone-side end portion (other end portion)
26 resonance end
28 reflecting surface
50 microphone
52 microphone mount
54 inner space of microphone
80 one-sided closed resonance model

What is claimed is:

1. A sound collecting device comprising:
a plurality of resonant tubes of different lengths, each formed in a tubular shape and having a sound collecting opening formed at one end portion; and
a microphone disposed at an other end portion of each of the resonant tubes,
wherein each of the resonant tubes has a reflecting surface extending toward an inside of the resonant tube at a predetermined distance from the sound collecting opening and the microphone.

2. The sound collecting device according to claim 1, wherein each of the resonant tubes includes
a sound collecting resonator formed to include the sound collecting opening, the reflecting surface, and a section extending from the sound collecting opening to the reflecting surface, and
a narrow tube portion that is formed with a smaller cross-sectional area than the sound collecting resonator and connects the sound collecting resonator to the microphone.

3. The sound collecting device according to claim 2, wherein the narrow tube portion is formed with a smaller cross-sectional area than an outer shape of the microphone.

4. The sound collecting device according to claim 2, wherein the sound collecting opening is formed on a sound collecting surface that is formed of a flat surface facing the microphone,
each of the resonant tubes is disposed in an arrangement around the microphone, and
among the plurality of resonant tubes of different lengths, the resonant tube with a shorter overall length of the sound collecting resonator is disposed on a center side, and the resonant tube with a longer overall length of the sound collecting resonator is disposed outside the resonant tube with the shorter overall length of the sound collecting resonator.

5. The sound collecting device according to claim 2, wherein the narrow tube portion includes a plurality of narrow tube portions, and a plurality of the narrow tube portions are combined and connected to the microphone.
